(19) United States
(12) Patent Application Publication
(10) Pub. No.: US 2011/0153322 A1
(43) Pub. Date: Jun. 23, 2011

(54) DIALOG MANAGEMENT SYSTEM AND METHOD FOR PROCESSING INFORMATION-SEEKING DIALOGUE

(75) Inventors: Byung-Kwan KWAK, Yongin-si (KR); Jeong-Mi Cho, Seongnam-si (KR)

(73) Assignee: SAMSUNG ELECTRONICS CO., LTD., Suwon-si (KR)

(21) Appl. No.: 12/912,631

(22) Filed: Oct. 26, 2010

(30) Foreign Application Priority Data
Dec. 23, 2009 (KR) 10-2009-0129942

(51) Int. Cl. G10L 15/26; G10L 11/00

(52) U.S. Cl. 704/235; 704/270; 704/E15.043; 704/E15.001

(57) ABSTRACT

A dialog management apparatus and method for processing an information-seeking dialogue with a user and providing a service to the user by prompting the user for a task-oriented dialogue may be provided. A hierarchical topic plan in which pieces of information are organized in a hierarchy according to topics corresponding to services may be used to prompt the user to change an information-seeking dialogue to a task-oriented dialogue, and the user may be provided with a service.

### CROSS-REFERENCE TO RELATED APPLICATION(S)

This application claims the benefit under 35 U.S.C. §119(a) of Korean Patent Application No. 10-2009-0129942, filed on Dec. 23, 2009, in the Korean Intellectual Property Office, the entire disclosure of which is incorporated herein by reference for all purposes.

### BACKGROUND

1. Field

The following description relates to a dialog management system and method for seeking explicit user intention from an abstract interest of the user in a conversational interface that provides a service in a communicative manner through voice, text and multi-modal input, and providing a service according to the found explicit user intention.

2. Description of the Related Art

Generally, dialog domains include a goal-oriented dialog domain and an informative dialog domain.

According to the dialog domains, dialogues are classified into a task-oriented dialogue which is goal-oriented and substantially informative, and an information-seeking dialogue which is considerably informative but is not quite goal-oriented.

Most dialog systems provide a system initiative dialogue in which the system initiates and leads a task-oriented dialogue with a user and constraints the user's speech in a comparatively well defined domain, or a user initiative dialogue in which the user speaks an explicit intention in a manner that makes the dialogue easily understood the system.

However, with the increasing variety and complexity of subjects (domains) and services to be provided by a dialog system, it becomes more and more difficult for the users to achieve a desired service by clearly showing their intentions with sufficient knowledge of functions of the system. Furthermore, the users have difficulties in knowing how to communicate with the dialog system to obtain a service that they want, and especially, for those not accustomed with the use of the dialog system, they may frequently mention vague or ambiguous intentions which fall under information-seeking intentions.

That is, the users may be unable to request a desired service even if they have an interest in a service domain. If the dialog system cannot respond to such occasion, it is difficult for the users to obtain services that suit their intentions using an interface.

Accordingly, the conventional dialog management method for a task-oriented dialogue suitable for a standardized domain cannot process a non-standardized information-seeking dialogue, and there is a need for a dialog system that can analyze a user's intention from the information-seeking dialogue and prompt the user for a task-oriented dialogue to provide a service.

### SUMMARY

In one general aspect, there is provided a dialog system, including: a speech recognition unit configured to recognize a sound signal from a user as text, a spoken language understanding unit configured to identify a user intention based on the recognized text, a dialog management unit configured to: prompt the user for a task-oriented intention in association with a hierarchical topic plan in which pieces of information related to each topic corresponding to a service are organized in a hierarchy, in response to the identified user intention being an information-seeking intention, and select a service that satisfies the user intention, and a response management unit configured to generate a response corresponding to the selected service and provide the generated response to the user.

The dialog system may further include that the dialog management unit includes: a disambiguation unit configured to disambiguate the identified user intention as either an information-seeking intention or a task-oriented intention, according to whether the identified user intention is related to a direct request for the service, an information-seeking dialog handler unit configured to: in response to the disambiguation unit determining that the identified user intention is an information-seeking intention, search the hierarchical topic plan to find a topic corresponding to an interest contained in the information-seeking intention, and generate a response to confirm a user intention regarding a lower layer topic of the found topic corresponding to the interest, and a response generation unit configured to generate the response in the form of a user interface.

The dialog system may further include that the dialog management unit includes: a disambiguation unit configured to disambiguate the identified user intention as either an information-seeking intention or a task-oriented intention, according to whether the identified user intention is related to a direct request for the service, a domain action handler unit configured to select the service that satisfies the user intention using the hierarchical topic plan, in response to the disambiguation unit determining that the identified user intention is a task-oriented intention, and a response generation unit configured to generate the selected service in the form of a user interface.

The dialog system may further include that the disambiguation unit includes: a user intention simplification unit configured to simplify a plurality of user intentions, the plurality of user intentions being identified by the spoken language understanding unit into one intention of user's, a multiple-choice question generation unit configured to generate a multiple-choice question to allow the user to select the service that satisfies the user intention from among services corresponding to the plurality of user intentions, in response to the plurality of user intentions not being simplified by the user intention simplification unit, and a user intention classification unit configured to clarify whether the simplified user intention is an information-seeking intention or a task-oriented intention.

The dialog system may further include that: the hierarchical topic plan is configured to: locate a topic node, related to a primary subject of a provided service, at a highest level, classify information according to subordinate subjects of a highest topic node, locate the information at lower nodes according to the information-seeking intention of the user, and locate topic nodes related to the most specific subjects of the provided service at a lowest level, the topic nodes being classified according to the task-oriented intention of the user, and the hierarchical topic plan includes each of the topic nodes, each topic node including a precondition, an action, and an effect, the precondition being information desired for providing the service corresponding to the topic node, the action being information indicating the provided service, the effect being information indicating the result caused by providing the service.

The dialog system may further include that the information-seeking dialog handler unit includes: a topic node search unit configured to search the hierarchical topic plan to find a topic node placed at a specific layer corresponding to the identified user intention, a precondition determination unit configured to: determine whether a current status of the user according to the user intention satisfies a precondition of the found topic node, and select a service corresponding to the topic node, in response to the current status satisfying the precondition, a lower topic node search unit configured to: search the hierarchical topic plan to find a lower topic node located at a lower level of the topic node, in response to the current status not satisfying the precondition, and control the precondition determination unit to determine whether the current status of the user satisfies a precondition of the found lower topic node, in response to the lower topic node being present, and an alternative response proposal unit configured to propose an alternative response to the user, in response to the lower topic node search unit not finding a lower topic node.

The dialog system may further include that the domain action handler unit includes: an input parameter check unit configured to check whether the task-oriented intention contains all parameters desired for providing a corresponding service, and a user intention adding unit configured to request the user to additionally input additional parameters, in response to some or all parameters not present being in the task-oriented intention.

The dialog system may further include that the domain action handler unit further includes: a reliability check unit configured to check whether all of the input parameters contained in the task-oriented intention are valid, in response to the task-oriented intention containing all input parameters desired for providing the corresponding service, and a user intention confirmation unit configured to request the user to re-input a parameter, in response to the parameter contained in the task-oriented intention not being valid.

In another general aspect, there is provided a dialog management method using hierarchical topic plan for processing an information-seeking intention of a user in which the hierarchical topic plan is configured to have pieces of information organized in a hierarchy according to topics corresponding to services, the dialog management method including: in response to a user intention corresponding to a topic node located at a highest level or a lower level in the hierarchical topic plane, and in response to a current status of a user according to the user intention satisfying a precondition of the corresponding topic node, providing topic nodes subordinate to the corresponding topic node, and allowing the user to select a topic node corresponding to the user intention from the provided subordinate topic nodes, wherein the providing of the topic nodes and the allowing of selecting the topic node are repeatedly performed.

The dialog management method may further include that: the hierarchical topic plan is configured to: locate a topic node, related to a primary subject of a provided service, at the highest level, classify information according to subordinate subjects of the highest topic node, locate the information at lower nodes, according to the information-seeking intention of the user, locate topic nodes related to the most specific subjects of the provided service at a lowest level, the topic nodes being classified according to the task-oriented intention of the user, and the hierarchical topic plan includes each of the topic nodes, each of the topic nodes including a precondition, an action, and an effect, the precondition being information desired for providing the service corresponding to the topic node, the action being information indicating the provided service, the effect being information indicating the result caused by providing the service.

The dialog management method may further include: disambiguating the identified user intention as either an information-seeking intention or a task-oriented intention, according to whether the identified user intention is related to a direct request for the service, in response to the disambiguation unit determining that the identified user intention is an information-seeking intention, searching the hierarchical topic plan to find a topic corresponding to an interest contained in the information-seeking intention, generating a response to confirm a user intention regarding a lower layer topic of the found topic corresponding to the interest, the response being generated in the form of a user interface.

The dialog management method may further include: disambiguating the identified user intention as either an information-seeking intention or a task-oriented intention, according to whether the identified user intention is related to a direct request for the service, selecting the service that satisfies the user intention using the hierarchical topic plan, in response to determining that the identified user intention is a task-oriented intention, and generating the selected service in the form of a user interface.

The dialog management method may further include: simplifying a plurality of user intentions, the plurality of user intentions being identified by the spoken language understanding unit into one intention of a user, generating a multiple-choice question to allow the user to select the service that satisfies the user intention from among services corresponding to the plurality of user intentions, in response to the plurality of user intentions not being simplified by the user intention simplification unit, and clarifying whether the simplified user intention is an information-seeking intention or a task-oriented intention.

The dialog management method may further include: locating a topic node, related to a primary subject of a provided service, at a highest level, each topic node including a precondition, an action, and an effect, the precondition being information desired for providing the service corresponding to the topic node, the action being information indicating the provided service, the effect being information indicating the result caused by providing the service, classifying information according to subordinate subjects of a highest topic node, locate the information at lower nodes according to the information-seeking intention of the user, and locating topic nodes related to the most specific subjects of the provided service at a lowest level, the topic nodes being classified according to the task-oriented intention of the user.

The dialog management method may further include: searching the hierarchical topic plan to find a topic node placed at a specific layer corresponding to the identified user intention, determining whether a current status of the user according to the user intention satisfies a precondition of the found topic node, selecting a service corresponding to the topic node, in response to the current status satisfying the precondition, searching the hierarchical topic plan to find a lower topic node located at a lower level of the topic node, in response to the current status not satisfying the precondition, controlling the precondition determination unit to determine whether the current status of the user satisfies a precondition of the found lower topic node, in response to the lower topic node being present, and proposing an alternative response to the user, in response to the lower topic node search unit not finding a lower topic node.

The dialog management method may further include: checking whether the task-oriented intention contains all parameters desired for providing a corresponding service, and requesting the user to additionally input additional parameters, in response to some or all parameters not present being in the task-oriented intention.

The dialog management method may further include: checking whether all of the input parameters contained in the task-oriented intention are valid, in response to the task-oriented intention containing all input parameters desired for providing the corresponding service, and requesting the user to re-input a parameter, in response to the parameter contained in the task-oriented intention not being valid.

Other features and aspects may be apparent from the following detailed description, the drawings, and the claims.

### BRIEF DESCRIPTION OF THE DRAWINGS

FIG. 1 is a diagram illustrating an example of dimensions of a dialogue which are categorized based on the purpose of the dialogue.

FIG. 2 is a diagram illustrating an example of dimensions of a dialogue for showing a concept of a dialog management method for processing information-seeking dialogue.

FIG. 3 is a diagram illustrating an example of a dialog system.

FIG. 4 is a diagram illustrating an example of a specified configuration of the dialog management unit of the dialog system of FIG. 3.

FIG. 5 is a diagram illustrating an example of a specified configuration of a disambiguation unit of the dialog system of FIG. 4.

FIG. 6 is a diagram illustrating an example of data included in the hierarchical topic plan shown in the example illustrated in FIG. 4.

FIG. 7 is a diagram illustrating an example of a specified configuration of an information-seeking dialog handler unit of the dialog system of FIG. 4.

FIG. 8 is a diagram illustrating an example of a specified configuration of a domain action handler of the dialog system of FIG. 3.

FIGS. 9A and 9B show an example of a hierarchical topic plan of a robot service dialog system.

FIGS. 10A to 10E show an example of a dialog process between a user and a dialog system employing a hierarchical topic plan.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. The progression of processing steps and/or operations described is an example; however, the sequence of steps and/or operations is not limited to that set forth herein and may be changed as is known in the art, with the exception of steps and/or operations necessarily occurring in a certain order. Also, descriptions of well-known functions and constructions may be omitted for increased clarity and conciseness.

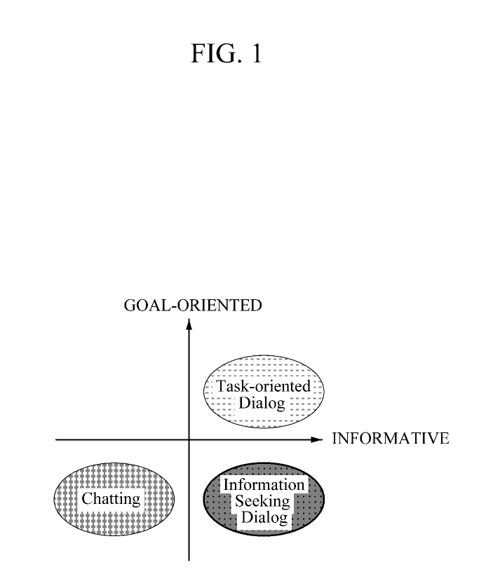

FIG. 1 illustrates an example of dimensions of a dialogue which are categorized based on the purpose of the dialogue. Referring to the example illustrated in FIG. 1, dialog dimensions may include a task-oriented dialogue, an information-seeking dialogue, and a chat dialogue.

Most conventional dialog systems are involved in a task-oriented dialogue for the purpose of provision of a real service suitable for a standardized domain.

The task-oriented dialogue may be involved in, for example, the reservation of a train/flight ticket and the control of electronic appliances. An example of the task-oriented dialogue is as follows:
User: I want to book a train ticket to Busan tomorrow afternoon.
System: Where do you depart from?
User: from Seoul
System: When is your departure time?

The chat-dialogue may be, for example, a daily-life conversation and may involve private lives. An example of the chat-dialogue is as follows:
User 1: Ah, I′m tired.
User 2: Are you? Recently I feel pretty tired too.
User 1: Yeah, I get easily tired when the seasons change.
User 2: Then, let's go out to have something healthy and yummy that makes us feel better.

The information-seeking dialogue may be a conversation which has no explicit intent or purpose of the speech and exhibits only an ambiguous interest in the topic of the conversation. The information-seeking dialogue may be related to a service to be offered, but may not represent a specific or concrete request for an exact service. An example of the information-seeking dialogue is as follows:
User: Tell me about Rome.
System: Rome is one of the historic cities of the western world, with a mixture of ancient architecture and culture . . . .
User: Is it? What ancient architecture is in Rome, for example?
System: The Colosseum, the Arch of Constantine, and the like.
User: Please tell me about The Colosseum.

As shown in the example, the user may speak of a subject domain related to the service, but may not directly request the service that is provided by the dialog system. Meanwhile, the utterances of the user may be more like questions about the service itself (it may be considered meta-information) than requests for the services. The types of conversations, services, and information are not limited to the example described herein.

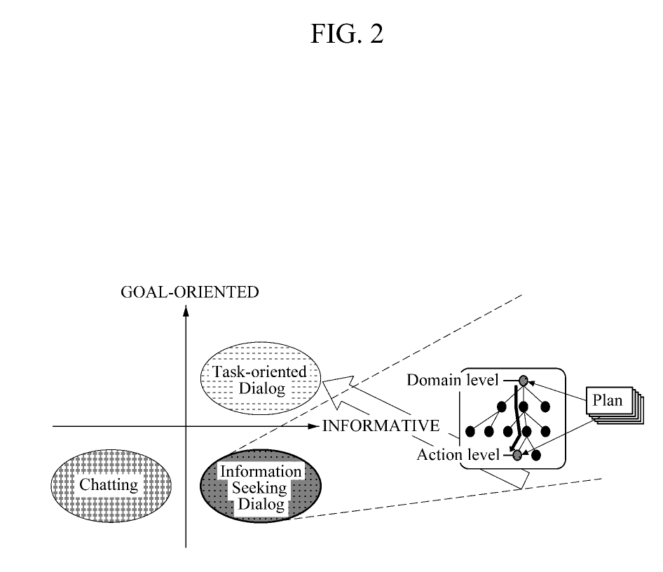

FIG. 2 illustrates an example of dimensions of a dialogue for showing a concept of a dialog management method for processing an information-seeking dialogue.

The dialog management method shown in the example illustrated in FIG. 2 may use a topic hierarchy that shows hierarchical relationships between topics of the information-seeking is dialogue to lead the dialogue in a natural manner to clarify the clear intent of the user's speech from the user's abstract interests in the topics.

A topic hierarchy of domains may be searched based on a user's interest exhibited from the information-seeking dialogue. During the course of the dialogue with the user, the dialogue may be led from a topic in a domain level to a topic of an action level that involves a task-oriented intention, and a real service corresponding to a user's intention may be provided to the user.

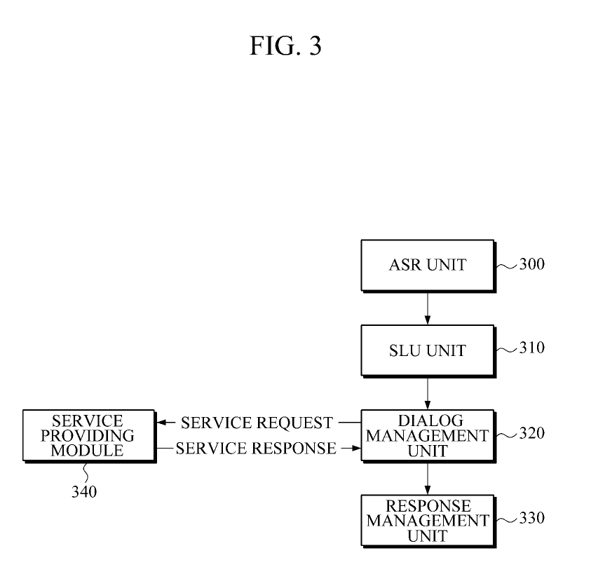

FIG. 3 illustrates an example of a dialog system. Referring to the example illustrated in FIG. 3, the dialog system may include an automatic speech recognition (ASR) unit 300, a spoken language understanding (SLU) unit 310, a dialog management unit 320, and a response management unit 330.

The ASR unit 300 may recognize a sound signal from a user's speech, and may convert the sound signal into text. The SLU unit 310 may analyze the recognized text to nominate possible user intentions.

The dialog management unit 320 may select a final user intention that matches with the dialog situation from among the possible user intentions, issue a service request to a service providing module 340, and receive a service result as a response from the service providing module 340 that may provide a real service.

The response management unit 330 may transmit the received service result to the user.

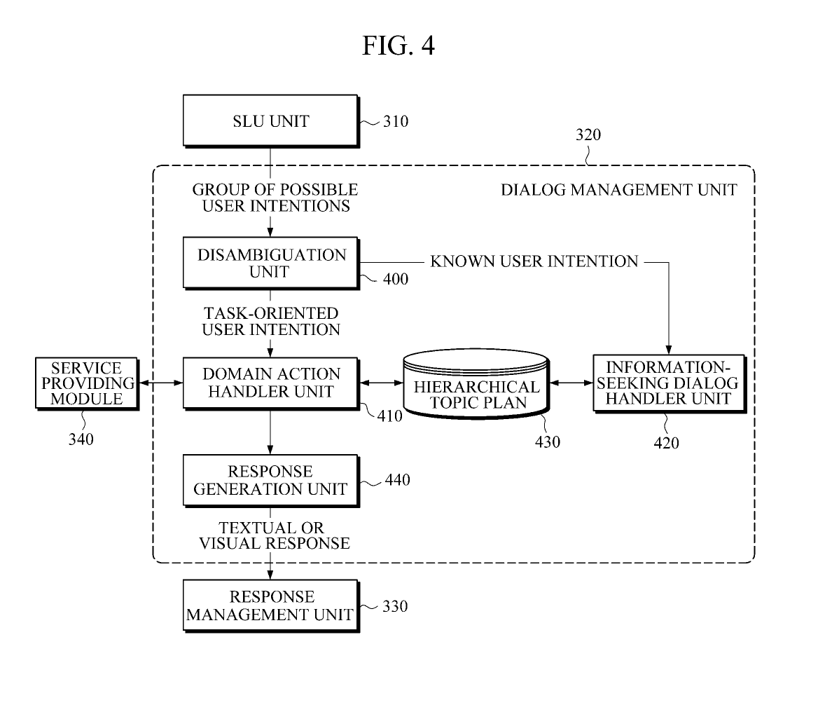

The dialog management unit 320 may prompt the user to clarify the user's intention through the interaction with the system in response to it being determined that an analyzed user's intention is not unambiguous enough to provide the exact service. The operation of the dialog management unit 320 will be described in detail with reference to FIG. 4.

FIG. 4 illustrates an example of a specified configuration of the dialog management unit of the dialog system of FIG. 3. Referring to the example illustrated in FIG. 4, the dialog management unit 320 may include a disambiguation unit 400, a domain action handler unit 410, an information-seeking dialog handler unit 420, a hierarchical topic plan 430, and a response generation unit 440.

The disambiguation unit 400 may categorize the possible user intentions resulting from analyzing the recognized text by the SLU unit 320 into a task-oriented group and an information-seeking intention group. The task-oriented group may include the possible user intentions that contain information of a concrete request for a service provided by the dialog system. The information-seeking intention group may include the possible user intentions that do not include any information of a specific request. That is, the dialogue between the dialog system and the user may be classified into an information-seeking dialogue in which the user does not express a clear intent of the speech, and a task-oriented dialogue that exhibits a standardized intent of the speech corresponding to a domain action in the form of an instruction that directs the dialog system to provide a specific service.

During the course of the information-seeking dialogue, the information-seeking dialog handler unit 420 may instruct the response generation unit 440 to generate a response that prompts the user to express a user's intention of a lower level of the hierarchical topic plan from the open user intentions. The user's intention of the lower level may allow the dialog system to perform a specific service.

During the course of the task-oriented dialogue, the domain action handler unit 410 may communicate with the service providing module 340 that may provide the real service, and may make a final decision about a service to be offered to the user. Pieces of information desired for the real service request may be obtained from the hierarchical topic plan 430.

The response generation unit 440 may generate appropriate responses using a user interface, such as a text to speech (TTS) interface and a graphical user interface, to be output from the dialog management unit 320. The generated responses may be transmitted to the response management unit 330, and then sent to the user.

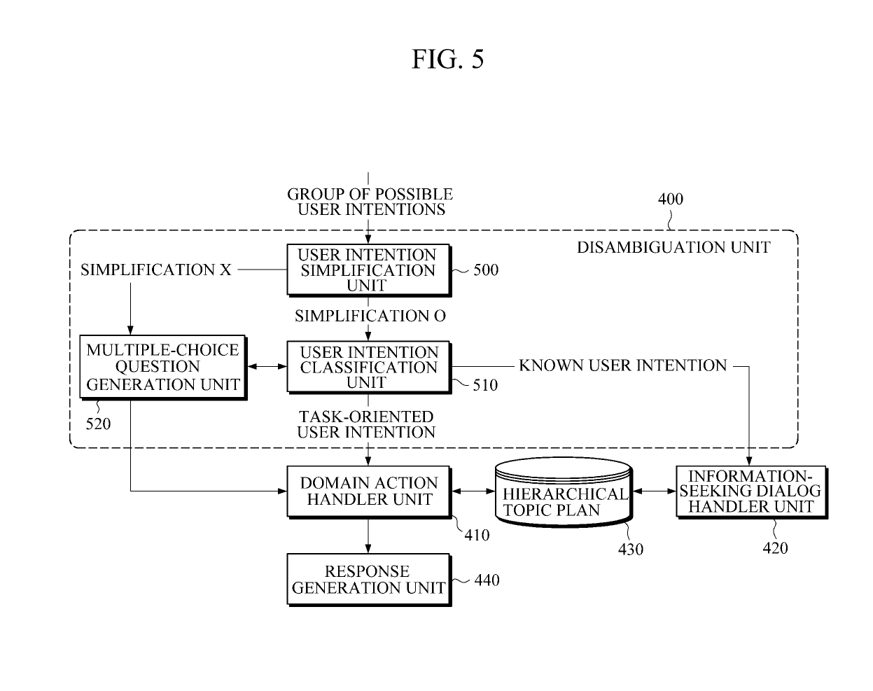

FIG. 5 illustrates an example of a specified configuration of a disambiguation unit of the dialog system of FIG. 4. Referring to the example illustrated in FIG. 5, the disambiguation unit 400 may include a user intention simplification unit 500, a user intention classification unit 510, and a multiple-choice question generation unit 520.

The disambiguation unit 400 may classify the possible user intentions into the task-oriented group and the information-seeking intention group.

The user intention simplification unit 500 may select the most definite intention of the user from a plurality of possible user intentions, or may unite the possible user intentions into the most definite user intention to resolve the ambiguity.

When the possible user intentions cannot be simplified by the user intention simplification unit 500, the multiple-choice question generation unit 520 may generate a multiple-choice question related to the possible user intentions in response to an input from the user, and may transmit the generated question to prompt the user to clarify his/her genuine intention.

The user intention classification unit 510 may determine whether the user intention selected by the user intention simplification unit 500 is a task-oriented intention or an information-seeking intention. The user intention classification unit 510 may determine whether the user intention contains information involved with the concrete request for a specific service or provision of a service based on a sentence-pattern-related algorithm or the like. The classified user intention may be processed by either the information-seeking dialog handler unit 420 or the domain action handler unit 410.

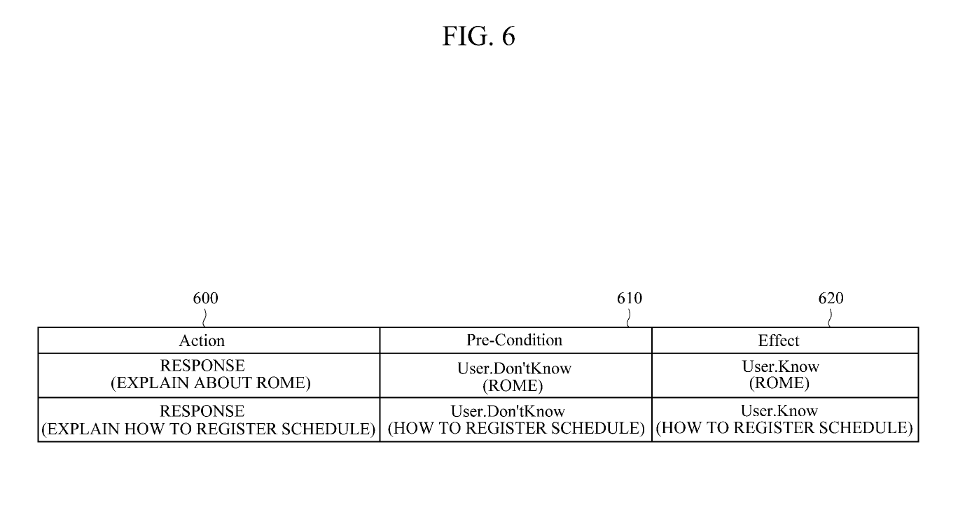

FIG. 6 illustrates an example of data included in the hierarchical topic plan shown in the example illustrated in FIG. 4.

The hierarchical topic plan utilized in the research of automated planning may primarily include three types of information, including an action 600, a precondition 610 for performing the action 600, and an effect 620 resulting from the execution of the action 600.

Status information used for the precondition 610 and the effect 620 may include a status of the user or the dialog system. For example, the status information may indicate whether the user is aware of specific information or has received a response from the dialog system.

Referring to the example shown in FIG. 6, an action 600 that explains about Rome may be taken according to the precondition 610 that the user does not know about Rome. As the effect of executing the action, the user may acquire knowledge of Rome. For example, any considerable combinations of the preconditions and the effects may be applied to the hierarchical topic plan. Accordingly, the dialog system may offer complex preconditions and handle various dialog situations.

In hierarchical topic plan modeling, the above information structure may be used for each dialog topic, and such information may be utilized for an ongoing dialogue by the dialog system while interacting with the user.

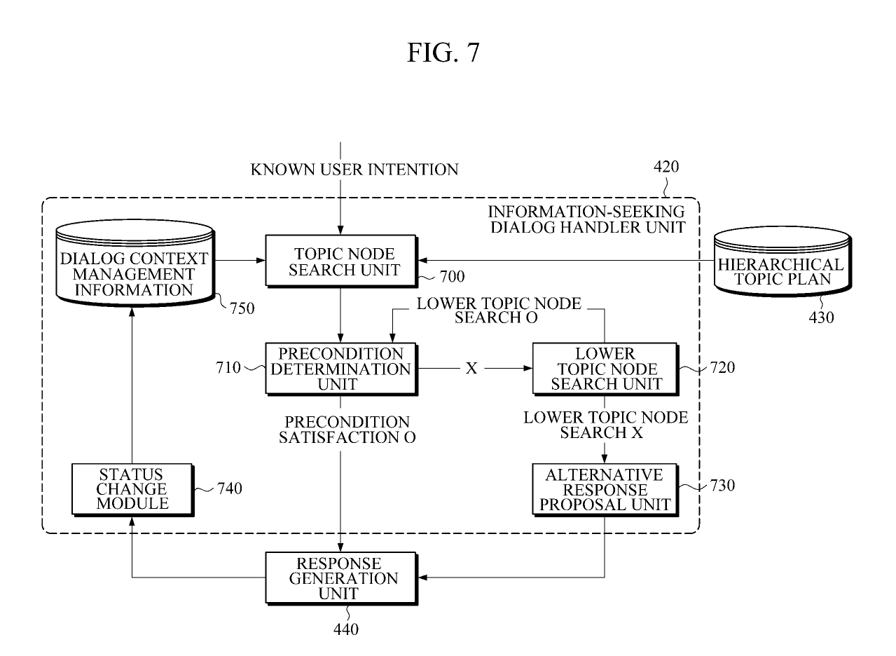

FIG. 7 illustrates an example of a specified configuration of an information-seeking dialog handler unit of the dialog system of FIG. 4. Referring to the example illustrated in FIG. 7, the information-seeking dialog handler unit 420 may include a topic node search unit 700, a precondition determination unit 710, a lower topic node search unit 720, and an alternative response proposal unit 730.

In response to the initiation of an information-seeking dialogue, the topic node search unit 700 may search for a topic node from the hierarchical topic plan 430, or may search for a current status of the ongoing dialogue from dialog context management information 750.

A position of the topic node may be stored in the dialog flow management information 750, according to the dialog flow, by updating status information resulting from the execution of a topic node. Although in the example illustrated in FIG. 7, the status update is performed by a status change module 740, the dialog context management information 750 may be implemented in the hierarchical topic plan 430. In addition, functions performed by the status change module 140 may be implemented to be added to elements within the information-seeking dialog handler unit 420.

The precondition determination unit 710 may compare the dialog context or a current status of the dialog context with a precondition specified in the corresponding topic node found by the topic node search unit 700.

In response to the current status meeting the precondition, an action specified in the topic node may be taken, and the result of the execution of the action is transmitted as a response to the user by the response generation unit 440. In response to the current status not meeting the precondition, the lower topic node search unit 720 may search for a lower topic node, which may be a child node of the topic node found by the topic node search unit 700. The structure of a service provided by the dialog system may be fed back to the user in the course of searching for the lower topic node, such that the user may understand the service structure of the dialog system and may be easily prompted to reach a task-oriented dialogue.

In response to the lower topic node being found, the precondition determination unit 710 may compare a precondition specified in the lower topic node with the current status of the dialog context. If the lower topic node is not found, the alternative response proposal unit 730 may provide the user with an alternative response such as suggestions of other services and an external information search.

As described above, the dialog context management information 750 and the status change module 740 may be configured in various forms. In the example illustrated in FIG. 7, the current status may be changed according to an effect specified in the topic node once the response generation unit 440 generates a response to the user. Accordingly, the current status of the dialog context may be continuously updated on the dialog context management information 750.

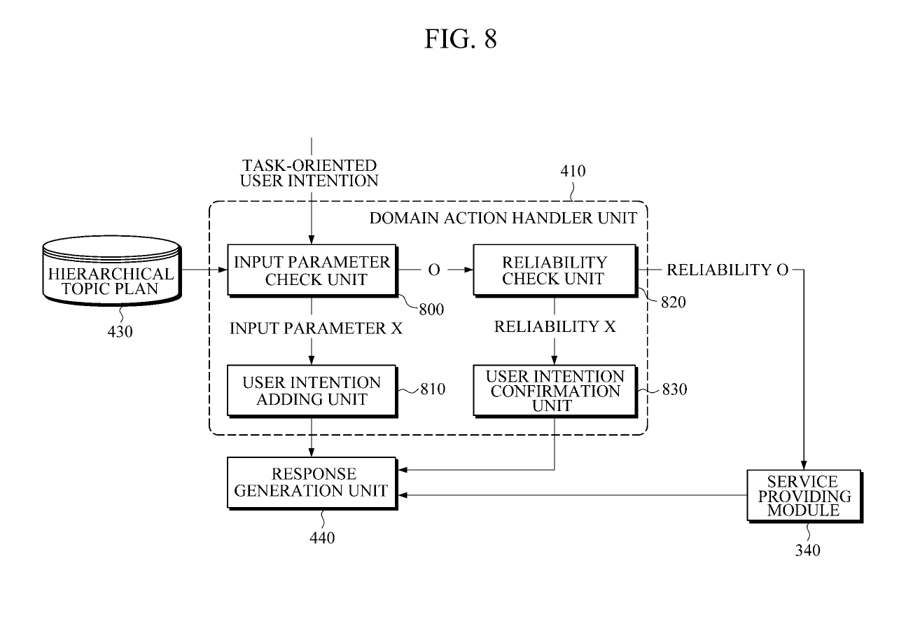

FIG. 8 illustrates an example of a specified configuration of a domain action handler of the dialog system of FIG. 3. Referring to the example illustrated in FIG. 8, the domain action handler unit 410 may include an input parameter check unit 800, a user intention adding unit 810, a reliability check unit 820, and a user intention confirmation unit 830.

The input parameter check unit 800 may take reference to the hierarchical topic plan to check whether input parameters desired for performing a domain action are included in a received task-oriented dialogue from the user.

In response to the received task-oriented dialogue not including a large enough number of parameters to perform the domain action, the user intention adding unit 810 may generate a sub-dialogue that requests the user to input relevant parameters, and may transmit the sub-dialogue to the user.

In response to all input parameters that are desired for performing the domain action being present, the reliability check unit 820 may measure the reliability of each input parameter to identify whether the input parameter is valid to perform the domain action without errors. The reliability may be obtained from a confidence value of an input parameter with respect to the speech recognition, spoken language understanding, and dialog management processes. The reliability may compensate for the possible misrecognition of the speech.

In response to the measured reliability being greater than a threshold value, the domain action may be performed through the communication with the service providing module 340, and a response may be generated according to the result of performing the domain action, and transmitted to the user.

For an input parameter, the reliability of which may not reach the threshold value, the user intention confirmation unit 830 may generate and transmit a sub-dialog for confirmation to the user, or may request the user to input the parameter again.

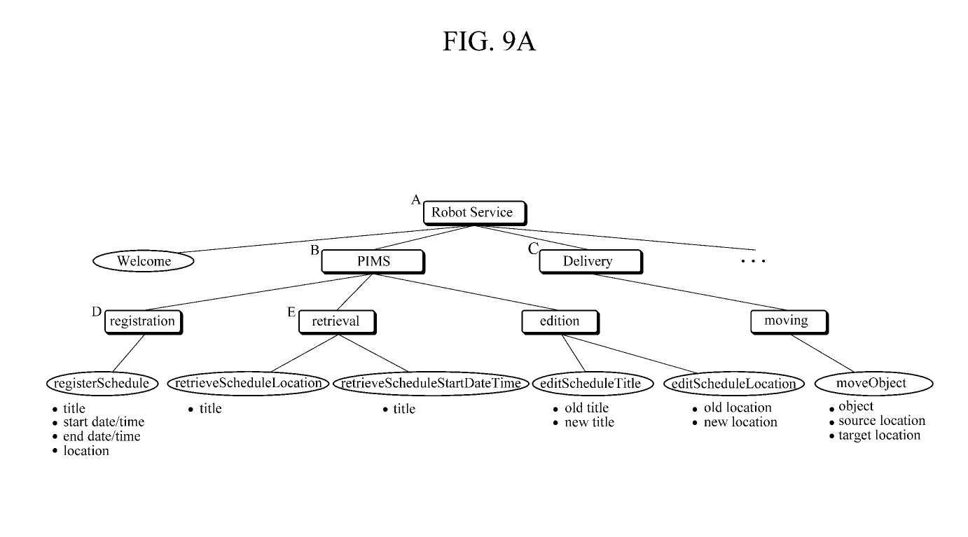

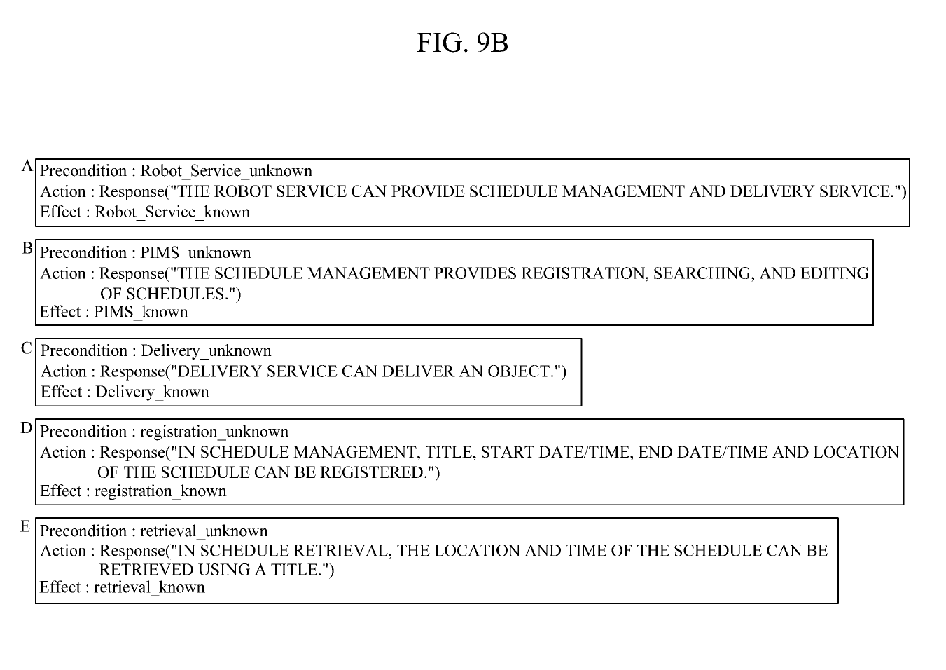

FIGS. 9A and 9B show an example of a hierarchical topic plan of a robot or automated service dialog system. Referring to the example shown in FIGS. 9A and 9B, topic nodes (information) may include information for making a response. The topic nodes may be arranged in a hierarchy structure (e.g., tree structure) and may be used for identifying position information of a dialogue with the user. Each topic node may include the information structure described with reference to FIG. 6 to allow the dialogue with the user to proceed.

That is, the current status of the dialogue with the user may be continuously managed to identify which topic node is currently being dealt with in the dialogue, and to determine a response of the system according to the current topic node. Thus, the topic nodes in a hierarchy structure may be used to manage the dialog flow.

In the example shown in FIG. 9A, rectangles with rounded corners denote internal nodes which primarily include topics related to an information-seeking dialogue. Ovals denote domain actions, each of which may contain a relevant topic corresponding to a task-oriented dialogue. Each domain action may include parameters desired for providing a specific function (or service).

For example, in FIG. 9A, four parameters including a title, a start time/date, an end time/date, and a location are desired to perform a domain action “registerSchedule.” The input parameter check may be performed on values registered for the parameters included in each domain action by the domain action handler unit 410 shown in the example illustrated in FIG. 8.

Each internal node represents a precondition for a corresponding action and an effect by the action, and reference letters “A”, “B”, “C”, “D”, and “E” in FIGS. 9A and 9B denote statuses of the preconditions and effects, respectively.

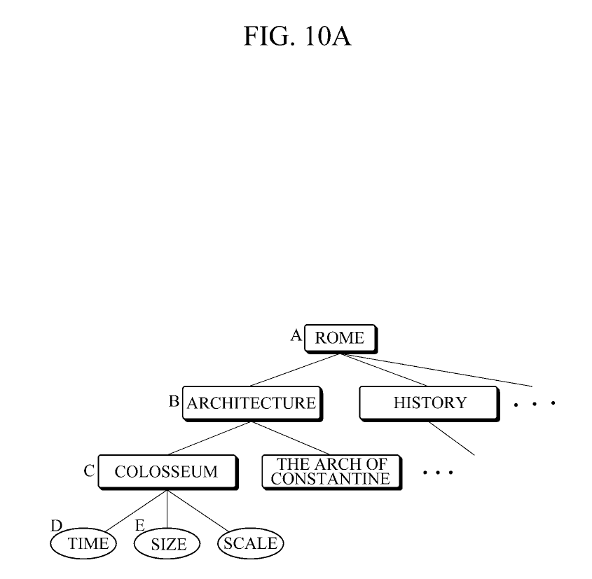

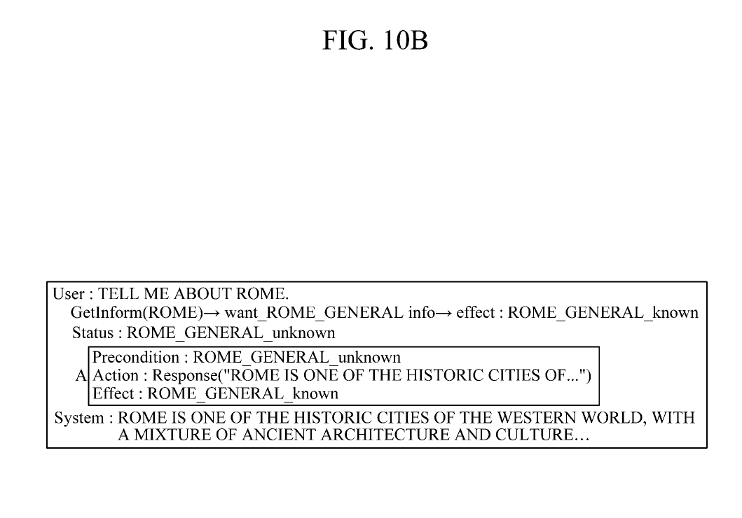

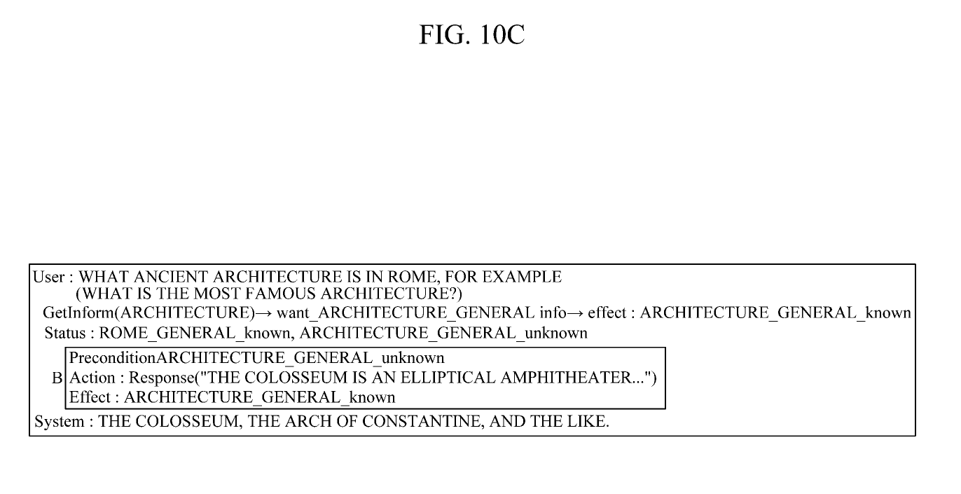

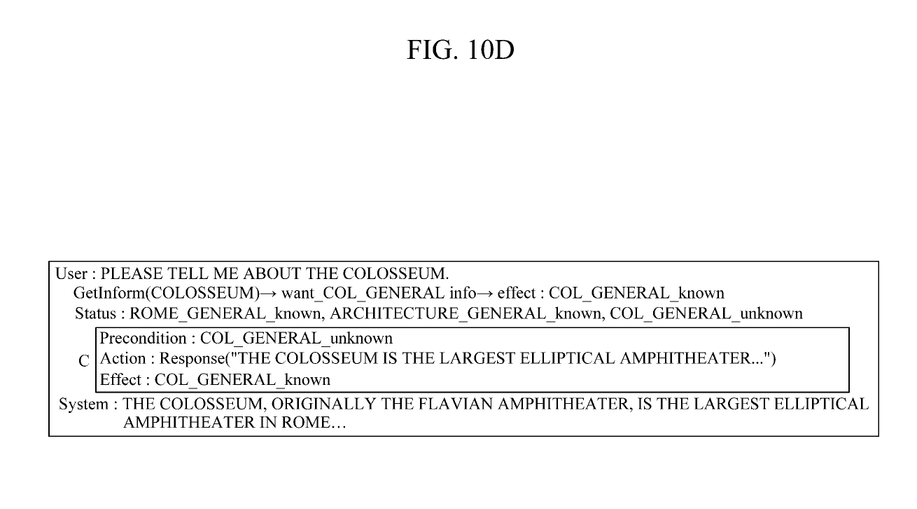

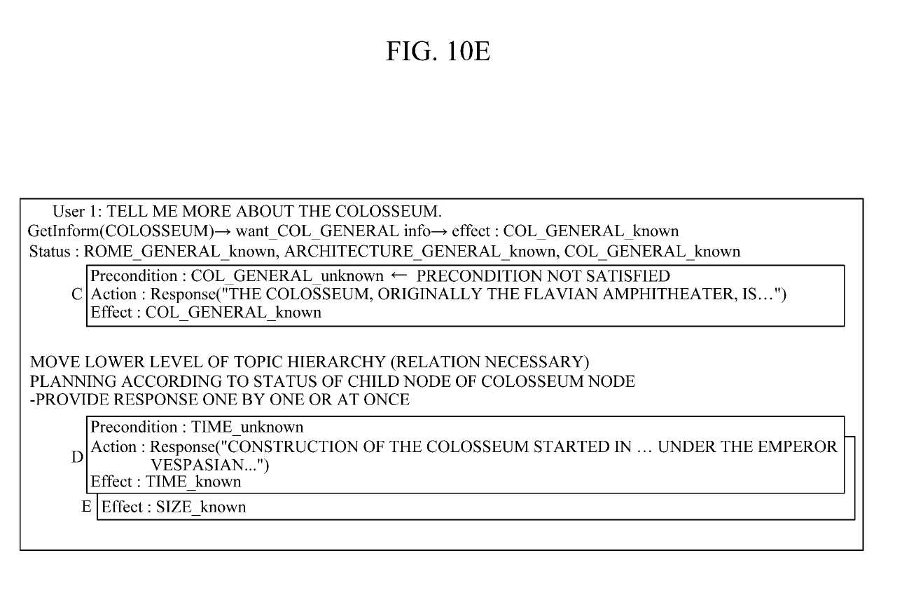

FIGS. 10A to 10E show an example of a dialog process between a user and a dialog system employing a hierarchical topic plan. The example shown in FIGS. 10A to 10E presumes that a dialogue takes place between a user and a guide avatar in a virtual space with Rome as a background.

When the user speaks a general request (e.g., “Tell me about Rome”), the current status may be placed on “Rome” which is a root internal node A of the hierarchical topic plan. In response to the user's showing his/her intention of achieving knowledge on Rome, the root internal node A may be detected while a service that meets the user's intention is being searched. In one example, as the user may not know about Rome (e.g., precondition: Rome_general_unknown), a corresponding action may be performed, and afterwards, an effect by the action may be updated (e.g., Effect: Rome_general_known).

In the next stage, with respect to a user's question about what architecture is in Rome (e.g., what ancient architecture is in Rome, for example?), the hierarchical topic plan may be searched to find an architecture topic node B, and the architecture topic node B may be checked, in a similar manner as performed for the root internal node A, whether a precondition is met. If the precondition is satisfied, a corresponding action may be performed, and an effect may be updated based on the result of the action. Then, for the next query (e.g., Please tell me about the Colosseum), a Colosseum topic node C may be found, and the desired procedures similar to the above may be performed on the found topic node C.

If the user speaks a query about the Colosseum later again (e.g., Give me more information about the Colosseum), the dialog system may find the Colosseum topic node C again, but the current status (e.g., Col_general_known) of the user in which the user has already obtained information of the Colosseum may not satisfy a precondition (e.g., Col_general_unknown) of the topic node C. Thus, the dialog system may search for lower nodes and then may perform an appropriate action of a lower topic node D or E according to a corresponding precondition.

The processes, functions, methods and/or software described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. The media and program instructions may be those specially designed and constructed, or they may be of the kind well-known and available to those having skill in the computer software arts. Examples of computer-readable media include magnetic media, such as hard disks, floppy disks, and magnetic tape; optical media such as CD-ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

As a non-exhaustive illustration only, the device described herein may refer to mobile devices such as a cellular phone, a personal digital assistant (PDA), a digital camera, a portable game console, and an MP3 player, a portable/personal multimedia player (PMP), a handheld e-book, a portable tablet and/or laptop PC, a global positioning system (GPS) navigation, and devices such as a desktop PC, a high definition television (HDTV), an optical disc player, a setup box, and the like consistent with that disclosed herein.

A computing system or a computer may include a microprocessor that is electrically connected with a bus, a user interface, and a memory controller. It may further include a flash memory device. The flash memory device may store N-bit data via the memory controller. The N-bit data is processed or will be processed by the microprocessor and N may be 1 or an integer greater than 1. Where the computing system or computer is a mobile apparatus, a battery may be additionally provided to supply operation voltage of the computing system or computer.

It will be apparent to those of ordinary skill in the art that the computing system or computer may further include an application chipset, a camera image processor (CIS), a mobile Dynamic Random Access Memory (DRAM), and the like. The memory controller and the flash memory device may constitute a solid state drive/disk (SSD) that uses a non-volatile memory to store data.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A dialog system, comprising:
a speech recognition unit configured to recognize a sound signal from a user as text;
a spoken language understanding unit configured to identify a user intention based on the recognized text;
a dialog management unit configured to:
prompt the user for a task-oriented intention in association with a hierarchical topic plan in which pieces of information related to each topic corresponding to a service are organized in a hierarchy, in response to the identified user intention being an information-seeking intention; and
select a service that satisfies the user intention; and
a response management unit configured to generate a response corresponding to the selected service and provide the generated response to the user.

2. The dialog system of claim 1, wherein the dialog management unit comprises:
a disambiguation unit configured to disambiguate the identified user intention as either an information-seeking intention or a task-oriented intention, according to whether the identified user intention is related to a direct request for the service;
an information-seeking dialog handler unit configured to:
in response to the disambiguation unit determining that the identified user intention is an information-seeking intention, search the hierarchical topic plan to find a topic corresponding to an interest contained in the information-seeking intention; and
generate a response to confirm a user intention regarding a lower layer topic of the found topic corresponding to the interest; and
a response generation unit configured to generate the response in the form of a user interface.

3. The dialog system of claim 1, wherein the dialog management unit comprises:
a disambiguation unit configured to disambiguate the identified user intention as either an information-seeking intention or a task-oriented intention, according to whether the identified user intention is related to a direct request for the service;
a domain action handler unit configured to select the service that satisfies the user intention using the hierarchical topic plan, in response to the disambiguation unit determining that the identified user intention is a task-oriented intention; and
a response generation unit configured to generate the selected service in the form of a user interface.

4. The dialog system of claim 2, wherein the disambiguation unit comprises:
is a user intention simplification unit configured to simplify a plurality of user intentions, the plurality of user intentions being identified by the spoken language understanding unit into one intention of the user;
a multiple-choice question generation unit configured to generate a multiple-choice question to allow the user to select the service that satisfies the user intention from among services corresponding to the plurality of user intentions, in response to the plurality of user intentions not being simplified by the user intention simplification unit; and
a user intention classification unit configured to clarify whether the simplified user intention is an information-seeking intention or a task-oriented intention.

5. The dialog system of claim 2, wherein:
the hierarchical topic plan is configured to:
locate a topic node, related to a primary subject of a provided service, at a highest level;
classify information according to subordinate subjects of a highest topic node;
locate the information at lower nodes according to the information-seeking intention of the user; and
locate topic nodes related to the most specific subjects of the provided service at a lowest level, the topic nodes being classified according to the task-oriented intention of the user; and
the hierarchical topic plan comprises each of the topic nodes, each topic node comprising a precondition, an action, and an effect, the precondition being information desired for providing the service corresponding to the topic node, the action being information indicating the provided service, the effect being information indicating the result caused by providing the is service.

6. The dialog management system of claim 5, wherein the information-seeking dialog handler unit comprises:
a topic node search unit configured to search the hierarchical topic plan to find a topic node placed at a specific layer corresponding to the identified user intention;
a precondition determination unit configured to:
determine whether a current status of the user according to the user intention satisfies a precondition of the found topic node; and
select a service corresponding to the topic node, in response to the current status satisfying the precondition;
a lower topic node search unit configured to:
search the hierarchical topic plan to find a lower topic node located at a lower level of the topic node, in response to the current status not satisfying the precondition; and
control the precondition determination unit to determine whether the current status of the user satisfies a precondition of the found lower topic node, in response to the lower topic node being present; and
an alternative response proposal unit configured to propose an alternative response to the user, in response to the lower topic node search unit not finding a lower topic node.

7. The dialog management system of claim 3, wherein the domain action handler unit comprises:
an input parameter check unit configured to check whether the task-oriented intention contains all parameters desired for providing a corresponding service; and
a user intention adding unit configured to request the user to additionally input additional parameters, in response to some or all parameters not present being in the task-oriented intention.

8. The dialog management system of claim 7, wherein the domain action handler unit further comprises:
a reliability check unit configured to check whether all of the input parameters contained in the task-oriented intention are valid, in response to the task-oriented intention containing all input parameters desired for providing the corresponding service; and
a user intention confirmation unit configured to request the user to re-input a parameter, in response to the parameter contained in the task-oriented intention not being valid.

9. A dialog management method using hierarchical topic plan for processing an information-seeking intention of a user in which the hierarchical topic plan is configured to have pieces of information organized in a hierarchy according to topics corresponding to services, the dialog management method comprising:
in response to a user intention corresponding to a topic node located at a highest level or a lower level in the hierarchical topic plane, and in response to a current status of a user according to the user intention satisfying a precondition of the corresponding topic node, providing topic nodes subordinate to the corresponding topic node; and
allowing the user to select a topic node corresponding to the user intention from the provided subordinate topic nodes,
wherein the providing of the topic nodes and the allowing of selecting the topic node are repeatedly performed.

10. The dialog management method of claim 9, wherein:
the hierarchical topic plan is configured to:
locate a topic node, related to a primary subject of a provided service, at the highest level;
classify information according to subordinate subjects of the highest topic node;
locate the information at lower nodes, according to the information-seeking intention of the user;
locate topic nodes related to the most specific subjects of the provided service at a lowest level, the topic nodes being classified according to the task-oriented intention of the user; and
the hierarchical topic plan comprises each of the topic nodes, each of the topic nodes comprising a precondition, an action, and an effect, the precondition being information desired for providing the service corresponding to the topic node, the action being information indicating the provided service, the effect being information indicating the result caused by providing the service.

11. The dialog management method of claim 9, further comprising:
disambiguating the identified user intention as either an information-seeking intention or a task-oriented intention, according to whether the identified user intention is related to a direct request for the service;
in response to the disambiguation unit determining that the identified user intention is an information-seeking intention, searching the hierarchical topic plan to find a topic corresponding to an interest contained in the information-seeking intention;
generating a response to confirm a user intention regarding a lower layer topic of the found topic corresponding to the interest, the response being generated in the form of a user interface.

12. The dialog management method of claim 9, further comprising:
disambiguating the identified user intention as either an information-seeking intention or a task-oriented intention, according to whether the identified user intention is related to a direct request for the service;
selecting the service that satisfies the user intention using the hierarchical topic plan, in response to determining that the identified user intention is a task-oriented intention; and
generating the selected service in the form of a user interface.

13. The dialog management method of claim 11, further comprising:
simplifying a plurality of user intentions, the plurality of user intentions being identified by the spoken language understanding unit into one intention of the user;
generating a multiple-choice question to allow the user to select the service that satisfies the user intention from among services corresponding to the plurality of user intentions, in response to the plurality of user intentions not being simplified by the user intention simplification unit; and
clarifying whether the simplified user intention is an information-seeking intention or a task-oriented intention.

14. The dialog management method of claim 11, further comprising:
locating a topic node, related to a primary subject of a provided service, at a highest level, each topic node comprising a precondition, an action, and an effect, the precondition being information desired for providing the service corresponding to the topic node, the action being is information indicating the provided service, the effect being information indicating the result caused by providing the service;
classifying information according to subordinate subjects of a highest topic node;
locate the information at lower nodes according to the information-seeking intention of the user; and
locating topic nodes related to the most specific subjects of the provided service at a lowest level, the topic nodes being classified according to the task-oriented intention of the user.

15. The dialog management method of claim 11, further comprising:
searching the hierarchical topic plan to find a topic node placed at a specific layer corresponding to the identified user intention;
determining whether a current status of the user according to the user intention satisfies a precondition of the found topic node;
selecting a service corresponding to the topic node, in response to the current status satisfying the precondition;
searching the hierarchical topic plan to find a lower topic node located at a lower level of the topic node, in response to the current status not satisfying the precondition;
controlling the precondition determination unit to determine whether the current status of the user satisfies a precondition of the found lower topic node, in response to the lower topic node being present; and
proposing an alternative response to the user, in response to the lower topic node search unit not finding a lower topic node.

16. The dialog management method of claim 15, further comprising:
checking whether the task-oriented intention contains all parameters desired for is providing a corresponding service; and
requesting the user to additionally input additional parameters, in response to some or all parameters not present being in the task-oriented intention.

17. The dialog management method of claim 16, further comprising:
checking whether all of the input parameters contained in the task-oriented intention are valid, in response to the task-oriented intention containing all input parameters desired for providing the corresponding service; and
requesting the user to re-input a parameter, in response to the parameter contained in the task-oriented intention not being valid.
